(19) United States
(12) Patent Application Publication
(10) Pub. No.: US 2015/0169196 A1
(43) Pub. Date: Jun. 18, 2015

(54) METHOD AND APPARATUS FOR CONTROLLING AN ELECTRONIC DEVICE SCREEN

(71) Applicant: Samsung Electronics Co., Ltd., Gyeonggi-do (KR)

(72) Inventor: Hoshin LEE, Gyeonggi-do (KR)

(21) Appl. No.: 14/569,963

(22) Filed: Dec. 15, 2014

(30) Foreign Application Priority Data
Dec. 13, 2013 (KR) 10-2013-0155819

(51) Int. Cl. G06F 3/0484; G06F 3/0481

(52) U.S. Cl. CPC G06F 3/04842; G06F 3/0481

(57) ABSTRACT

An electronic device is provided comprising a display unit and a controller configured to: display a screen on the display unit; in response to a first input, move the screen in a first direction by a first distance and hiding a first portion of the screen; and in response to an event generated while the screen is moving in the first direction, display a visual effect, the visual effect including bouncing the screen for a first time by moving the screen in a second direction by a second distance and hiding a second portion of the screen, wherein the second direction is opposite the first direction and the second distance is greater than the first distance.

### CROSS-REFERENCE TO RELATED APPLICATION

This application claims priority from and the benefit under 35 U.S.C. §119(a) of Korean Patent Application No. 10-2013-0155819, filed on Dec. 13, 2013, which is hereby incorporated by reference for all purposes as if fully set forth herein.

### BACKGROUND

1. Field of the Disclosure

The present disclosure relates to user interfaces and more particularly to a method and apparatus for controlling an electronic device screen.

2. Description of the Prior Art

As an increasing number of electronic devices have adopted touch screens, it is possible to conveniently and intuitively control the electronic devices by using touch interactions. As an example, it is possible to move a screen displayed on a touch screen in the up-and-down or left-and-right direction through a touch interaction.

However, if the boundary portion of the screen moved by performing the touch interaction in the up-and-down or left-and-right direction reaches the end of the display, then the screen cannot be moved further. When the screen cannot be moved further, the corresponding electronic device may display the boundary portion of the screen without any effect.

### SUMMARY

According to aspects of the disclosure, an electronic device is provided comprising a display unit and a controller configured to: display a screen on the display unit; in response to a first input, move the screen in a first direction by a first distance and hiding a first portion of the screen; and in response to an event generated while the screen is moving in the first direction, display a visual effect, the visual effect including bouncing the screen for a first time by moving the screen in a second direction by a second distance and hiding a second portion of the screen, wherein the second direction is opposite the first direction and the second distance is greater than the first distance.

According to aspects of the disclosure, an electronic device is provided comprising a display unit and a controller configured to: display a screen on the display unit; in response to a first input, move the screen in a first direction by a first distance until a boundary line of the screen reaches an end of the display unit; and bounce the screen for a first time by moving the screen in a second direction by a second distance and hide a second portion of the screen, wherein the second direction is opposite the first direction.

According to aspects of the disclosure, a method is provided comprising: displaying a screen on a display unit of an electronic device; in response to a first input, moving the screen in a first direction by a first distance and hiding a first portion of the screen; and in response to an event generated while the screen is moving in the first direction, displaying a visual effect, the visual effect including bouncing the screen for a first time by moving the screen in a second direction by a second distance and hiding a second portion of the screen, wherein the second direction is opposite the first direction and the second distance is greater than the first distance.

According to aspects of the disclosure, a method is provided comprising: displaying a screen on a display unit of an electronic device; in response to a first input, moving the screen in a first direction by a first distance until a boundary line of the screen reaches an end of the display unit; and bouncing the screen for a first time by moving the screen in a second direction by a second distance and hiding a second portion of the screen, wherein the second direction is opposite the first direction.

### BRIEF DESCRIPTION OF THE DRAWINGS

The above features and advantages of the present disclosure will be more apparent from the following detailed description in conjunction with the accompanying drawings, in which:

FIG. 1 is a diagram of an example of an electronic device, in accordance with aspects of the disclosure;

FIG. 2 is a flowchart of on example of a process, according to aspects of the disclosure;

FIG. 3, FIG. 4, and FIG. 5 are diagrams illustrating an example of a process for controlling screen movement, according to aspects of the disclosure;

FIG. 6A, FIG. 6B, and FIG. 6C are diagrams illustrating an example of a process for controlling screen movement, according to aspects of the disclosure;

FIG. 7A and FIG. 7B are diagrams illustrating an example of a process for controlling screen movement, according to aspects of the disclosure;

FIG. 8A, FIG. 8B, and FIG. 8C are diagrams illustrating an example of a process for controlling screen movement, according to aspects of the disclosure;

FIG. 9 is a flowchart of an example of a process, according to aspects of the disclosure;

FIG. 10A and FIG. 10B are diagrams illustrating an example of a process for controlling screen movement, according to aspects of the disclosure; and

FIG. 11A and FIG. 11B are diagrams illustrating an example of a process for controlling screen movement, according to aspects of the disclosure.

### DETAILED DESCRIPTION

Hereinafter, various aspects of the present disclosure will be described with reference to the accompanying drawings. However, it should be understood that there is no intent to limit the present disclosure to particular forms, and the present disclosure should be construed to cover all modifications, equivalents, and/or alternatives falling within the spirit and scope of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

As used herein, the expression “A or B”, “at least one of A and/or B”, or “one or more of A and/or B” may include any or all possible combinations of items enumerated together. For example, the expression “A or B”, “at least one of A and B”, or “at least one of A or B” may include (1) at least A, (2) at least B, or (3) both A and B.

An electronic device according to various aspects of the present disclosure, for example, may include at least one of a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), an MP3 player, a mobile medical appliance, a camera, and a wearable device (e.g., smart glasses, a head-mounted-device (HMD), electronic clothes, an electronic bracelet, an electronic necklace, an electronic appcessory, an electronic tattoo, a smart mirror, or a smart watch).

Hereinafter, an electronic device according to various aspects of the disclosure will be described with reference to the accompanying drawings. As used herein, the term “user” may indicate a person who uses an electronic device or another device which in some manner controls the operation of the electronic device.

The term “screen movement” means moving a screen output on the display region in the upward direction, in the downward direction, in the leftward direction, in the rightward direction, or in the diagonal direction through a screen movement gesture. In addition, when the screen is provided in the form of a larger screen than the display region (e.g., when a screen is enlarged and thereby a portion of the enlarged screen is displayed on the display region, or when one of a plurality of screens is displayed), the “screen movement” may be an operation for searching for portions other than the portion of the screen that is displayed on the display unit. With regard to this, the “screen movement” may be performed through a screen movement gesture, and the screen movement gesture may include one of dragging, flicking, and sweeping for scrolling the screen.

The term “boundary line of a screen” as used in embodiments of the present disclosure may mean the end of a screen displayed on the display region. Also, the “boundary line of a screen” may refer to the boundary of an object (e.g., scrollable list) that is included in a screen displayed on the display region.

Further, the term “blank area” as used throughout the present disclosure may be used as a term to denote an area for visually indicating that there is no further screen to be displayed. In other words, the “blank area” may refer to an empty area where no object is displayed. In addition, the “blank area” may be displayed with the same color as or a different color from the screen displayed on the display region.

Further, the term “visual feedback” as used in embodiments of the present disclosure may be defined as a term to denote moving a screen at least once in the direction of a screen movement gesture and the opposite direction to the screen movement gesture when the boundary line of the screen reaches the end of the display region.

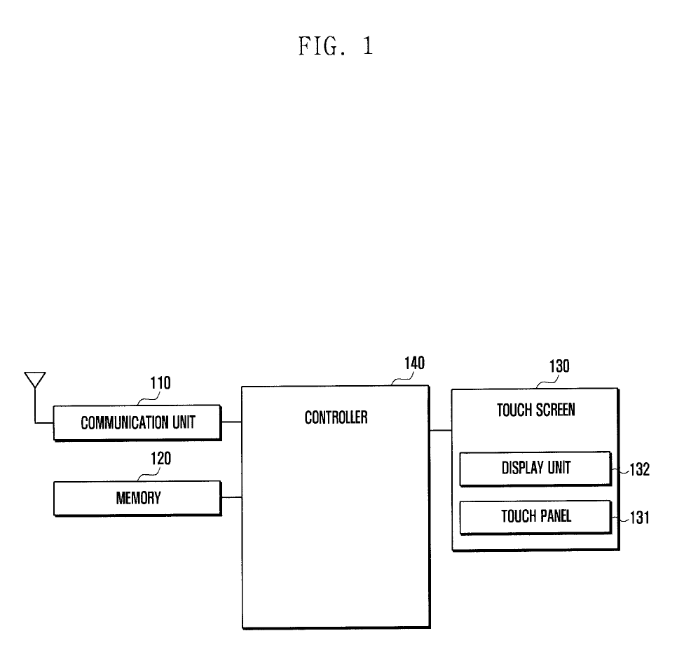

FIG. 1 is a diagram of an example of an electronic device, in accordance with aspects of the disclosure. As illustrated, the electronic device may include a communication unit 110, a memory 120, a touch screen 130, and a controller 140.

The communication unit 110 may establish communication between the electronic device and an external electronic device. As an example, the communication unit 110 may be connected to a network through wired or wireless communication to communicate with an external electronic device. The wireless communication, for example, may include wireless fidelity (Wi-Fi), Bluetooth (BT), near field communication (NFC), and the like. The wireless communication may also include at least one of cellular communications (e.g., LTE, LTE-A, CDMA, WCDMA, UMTS, WiBro, or GSM). The wired communication, for example, may include at least one of a universal serial bus (USB), a high definition multimedia interface (HDMI), recommended standard 232 (RS-232), and a plain old telephone service (POTS).

The memory 120 may include a program memory for storing an operation program of the electronic device and a data memory for storing data such as log information, contents, and objects generated in the process of executing a program.

Particularly, in an embodiment of the present disclosure, the memory 120 may store, under the control of the controller 140, one or more definitions of screen movement distances by which the screen is to be moved when a bouncing effect is applied to the screen. More specifically, in some implementations, the memory 120 may map different screen movement distance values to different respective values of the speeds of a screen movement gesture. As can be readily appreciated, the screen movement gesture may be one that triggers the display of the bouncing effect.

The touch screen 130 may be integrally formed to include a touch panel 131 and a display unit 132. The display unit 132 may display various screens according to the use of the electronic device under the control of the controller 140. The display unit 132 may include a liquid crystal display (LCD), a light emitting diode (LED) display, an organic light emitting diode (OLED) display, a microelectromechanical system (MEMS) display, or an electronic paper display. In addition, the display unit 132 may be implemented to be flexible, transparent, or wearable. The touch panel 131 may include a combined touch panel including a hand touch panel for detecting a hand gesture and a pen touch panel for detecting a pen gesture.

The controller 140 may include any suitable type of processing circuitry, such as a processor (e.g., an ARM-based process), a Field-Programmable Gate Array (FPGA), an Application-Specific Integrated Circuit (ASIC), etc. The controller 140 may control the overall operation of the electronic device and signal flow between internal elements of the electronic device, processes data, and controls power supply from a battery to the elements.

Particularly, in some implementations, the controller 140 may control the display unit 132 to display a screen. The controller 140 may detect a screen movement gesture for moving the screen through the touch panel 131 while the screen is displayed. In response to the screen movement gesture, the controller 140 may apply a bouncing effect to the screen. In some implementations, displaying the bouncing effect may include moving the screen back and forth as if the screen bounces off one or more imaginary walls.

In some aspects, the direction of the screen movement gesture may include one of up-and-down, left-and-right, and diagonal directions. The controller 140 may display the screen that is moved in the direction of the screen movement gesture in response to the detected screen movement gesture. The controller 140 may determine whether the boundary line of the screen reaches the end of the display region. In response to determining that the boundary line of the screen reaches the end of the display region, the controller 140 may apply a bouncing effect to the screen.

According to aspects of the disclosure, when it is determined that the boundary line of the screen reaches the end of the display region and the screen movement gesture is released, the controller 140 may display the screen the boundary line of which is moved by a first amount from the end of the display region in the direction of the screen movement gesture. The controller 140 may move the screen, which has been moved in the direction of the screen movement gesture, by a second distance larger than the first distance in the opposite direction to the screen movement gesture and display the moved screen. In addition, the controller 140 may move the screen, which has been moved in the opposite direction to the screen movement gesture, in the direction of the screen movement gesture again, and then stop the screen and display the stopped screen when the boundary line of the screen coincides with the end of the display region.

According to aspects of the disclosure, upon determining that the boundary line of the screen reaches the end of the display region, the controller 140 may move the screen in the opposite direction to the screen movement gesture, move the screen, which has been moved in the opposite direction to the screen movement gesture, in the direction of the screen movement gesture again, and then stop the screen and display the stopped screen when the boundary line of the screen coincides with the end of the display region.

In some implementations, the bouncing effect may include at least one “bounce.” Additionally or alternatively, in some implementations, when the bouncing effect is displayed, the movement distance of the screen may decrease with each successive bounce. For example, the distance by which the screen appears to travel past the bezel of the electronic device (and/or an end of a display region) may be greater the first time the screen bounces, than it is when the screen bounces for a second time. Specifically, in some implementations, the controller 140 may calculate the screen movement distance based on the speed of the screen movement gesture that triggers the presentation of the bouncing effect. After the display of the bouncing effect is completed, the controller 140 may display the screen in a static state in which the boundary line of the screen coincides with the end of the display region.

Further, the electronic device may optionally further include elements having additional functions, such as a global positioning system (GPS) module for receiving location information, an audio processing unit including a microphone and a speaker, a camera module for photographing an image or a moving image, a broadcast receiving module for receiving a broadcasting signal, and an input unit for supporting inputs based on hard keys, but the detailed description and illustration thereof will be omitted.

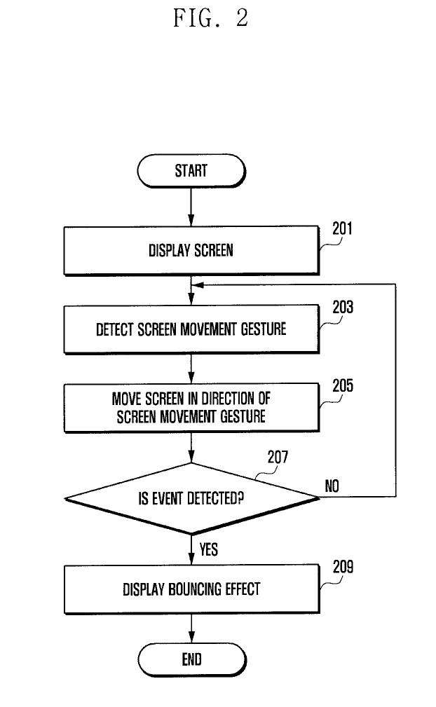

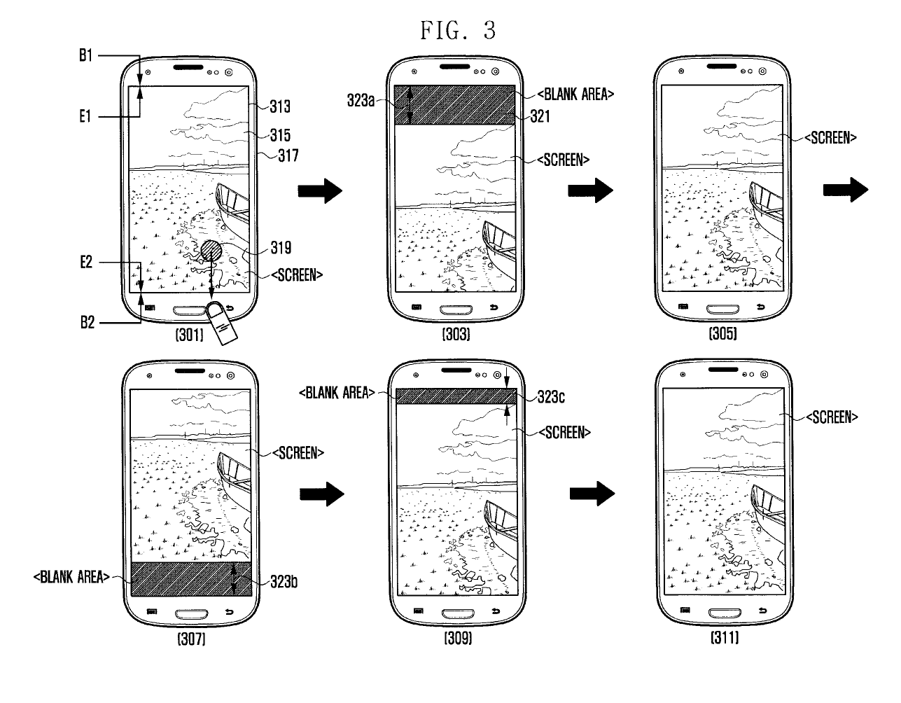

FIG. 2 is a flowchart of on example of a process, according to aspects of the disclosure. Referring to FIG. 2, the controller 140 may display a screen in operation 201. For example, the screen may be an application screen (e.g., a media player screen, an e-book screen, an Internet browser screen, etc.) a map, a menu comprising a plurality of icons, a menu comprising a plurality of thumbnails, a list of items (e.g., menu items, text items, link items), etc. In some implementations, the screen may be a scrollable screen.

In operation 203, the controller 140 may detect a screen movement gesture while the screen is displayed. For example, the screen movement gesture may include, but is not limited to, dragging, flicking, or sweeping for scrolling the screen. In the following, aspects of the present disclosure will be described assuming that the screen movement gesture is dragging. Additionally or alternatively, the detected screen movement gesture may include a gesture for moving the screen in any suitable direction, such as an upward direction, downward direction, leftward direction, rightward direction, a diagonal direction, etc.

In operation 205, the controller 140 may move the screen in the direction of the screen movement gesture. For example the controller 140 may move the screen along with the user's finger or stylus as the screen movement gesture is being performed by the user's finger or stylus.

In operation 207, the controller may determine whether a predetermined event is detected. For example, the controller 140 may determine whether the boundary line of the screen moved in the direction of the screen movement gesture reaches the end of the display region. As another example, the controller 140 may determine whether the screen has traveled by a predetermined distance. As yet another example, the controller 140 may determine whether the touch movement gesture is released.

In operation 209, the controller 140 may display a bouncing effect in response to the predetermined event being detected. According to aspects of the disclosure, displaying the bouncing effect may include moving the screen in one direction and then moving the screen again in the opposite direction, thereby giving the impression that the screen is bouncing off of an imaginary wall (or other object).

According to aspects of the present disclosure, upon detecting the screen movement gesture, the controller 140 may move the screen in the direction of the screen movement gesture and determine whether the boundary line of the screen moved in the direction of the screen movement gesture reaches the end of the display region. When the boundary line of the screen reaches the end of the display region, the controller 140 may continuously move the screen in the direction of the screen movement gesture and display a blank area on the display region. Here, the blank area may be displayed with the same color as or a different color from the displayed screen.

According to aspects of the disclosure, upon detecting a screen movement gesture for moving the screen in the first direction, the controller 140 may move the screen in the first direction. Upon determining that the boundary line of the screen moved in the first direction reaches the end of the display region, the controller 140 may display the screen the boundary line of which is moved by a first amount from the end of the display region in the first direction. Upon detecting that the screen movement gesture is released, the controller 140 may move the screen, which has been moved in the first direction, by a second amount larger than the first amount in the second direction. Since the screen is moved by the second amount larger than the first amount, the boundary line of the screen may be moved beyond the end of the display region in the second direction. The controller 140 may move the screen, which has been moved in the second direction, in the first direction again, and then stop the screen and display the stopped screen when the boundary line of the screen coincides with the end of the display region.

According to aspects of the disclosure, the screen may bounce at least once when the bouncing effect is displayed.

In some implementations, the screen's movement distance may be the distance by which an edge of the screen moves past an adjacent bezel edge and it may change as the screen bounces back and forth. When the controller 140 detects the bouncing event as the screen is moving in the first direction, the controller 140 may move the screen past one of the device's bezel edges by a distance of ½*D (where D is positive integer constant) in the second direction. The screen may then bounce in the first direction, thereby moving by a distance ¼*D past another one of the device's bezel edges. Further, the screen may again bounce in the second direction, thereby moving by a distance of ⅛*D, past the former bezel edge. Afterwards, in instances in instances in which: (1) the bouncing effect is configured to consist of two bounces, and (2) the size of the screen has been reduced to occupy less than the full display area of the device's touchscreen while the bouncing effect takes place, the screen may snap back to its full size, to again occupy the entire visible area of the device's touchscreen (e.g., display unit 132).

According to aspects of the disclosure, upon detecting the screen movement gesture for moving the screen in the first direction, the controller 140 may display the screen that is moved in the first direction. When the boundary line of the screen moved in the first direction reaches the end of the display region, the controller 140 may move the screen, which has been moved in the first direction, in the second direction opposite to the first direction. The controller 140 may move the screen, which has been moved in the second direction, in the first direction again, and then stop the screen and display the stopped screen when the boundary line of the screen coincides with the end of the display region.

According to aspects of the disclosure, the bouncing effect may be displayed as soon as the predetermined event is detected or may occur after a predetermined period of time (e.g., 3 seconds) since the detection of the predetermined event.

According to aspects of the disclosure, the distance by which the screen is moved when the bouncing effect (e.g., moving the screen in the first direction (or second direction) and in the second direction (or first direction)) is applied to the screen may be set by a user or may be determined automatically by the electronic device. In an embodiment of the present disclosure, the distance (hereinafter, “screen movement distance”) by which the screen is moved may mean the distance between the boundary line of the screen and the end of the display region.

Further, the speed at which the screen is moved may get faster or slower as time goes by. In some implementations, the number of times of bounces performed by the screen when the bouncing effect, the screen movement distance and the screen movement speed may be set in proportion to the speed of the screen movement gesture, as described below. In some implementations, the screen movement distance may include distance that the screen appears to travel past the bezel of the electronic device or past the ends of a given display region.

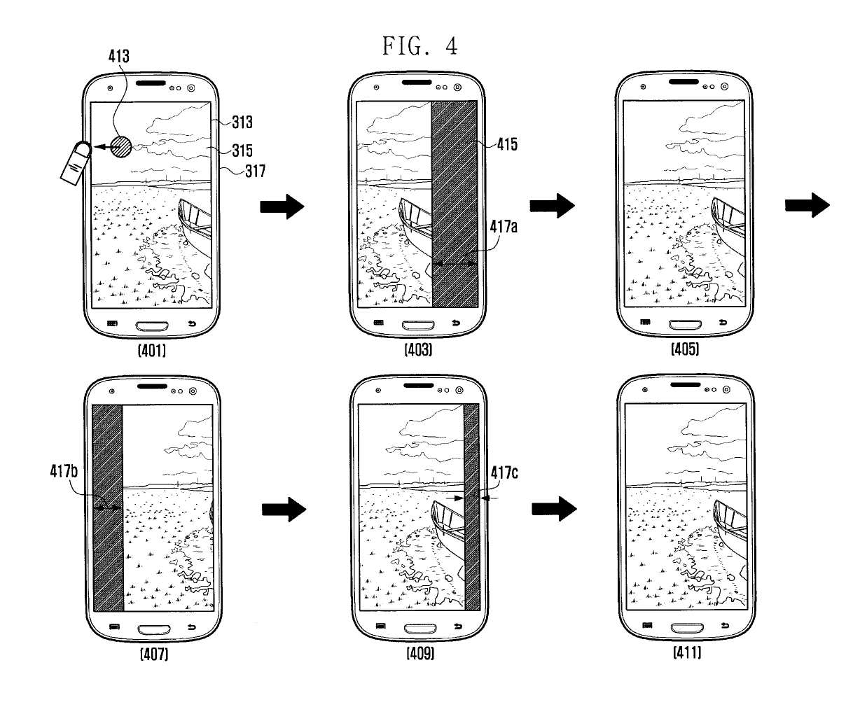

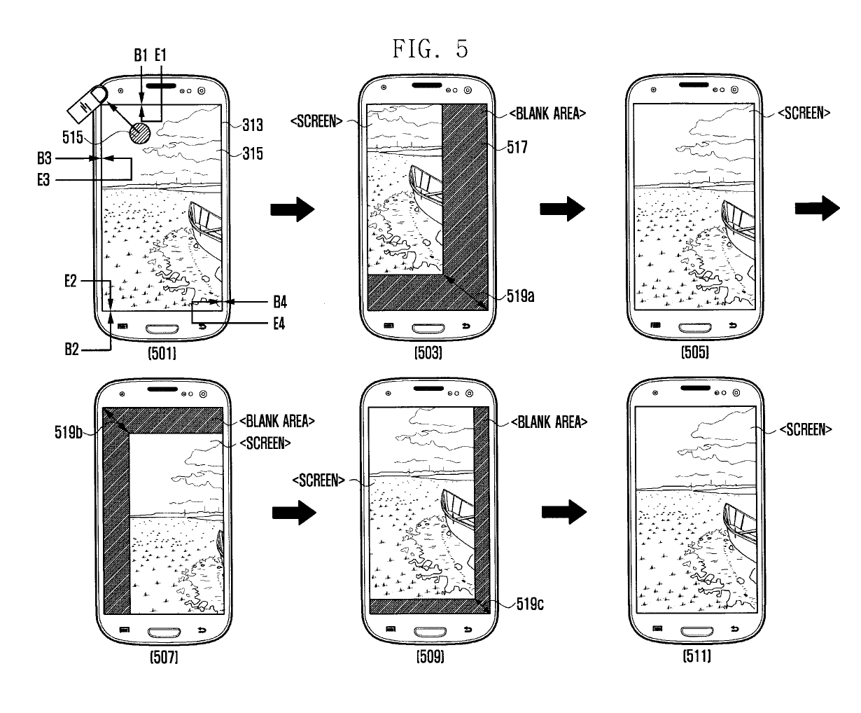

FIGS. 3-5 are diagrams illustrating an example of a process for controlling screen movement, according to aspects of the disclosure. Referring to FIG. 3, a reference numeral 313 may be an end of the display region between the display region 315 and the bezel region 317, as shown in diagram 301. When the bouncing gesture is detected on the screen, the screen may swing up and down with respect to the end 313 of the display region.

Specifically, when a touch 319 followed by a drag in a downward direction is detected on the screen, as shown in diagram 301, the controller 140 may determine whether the boundary line of the image reaches the end 313 of the display region. Upon determining that the boundary line of the image reaches the end 313 of the display region, the controller 140 may display the image that is moved down by the amount corresponding to the size 323a in the touch 319 followed by a drag in a downward direction, as shown in diagram 303 of FIG. 3. At this time, the dragging is still in progress. As the screen is being moved, a blank area 321 may be displayed. The blank area may visually inform that there are no more other screens and/or images to be displayed. At this time, a bouncing event may be detected on the screen, as shown in diagram 303. In response to the bouncing event (e.g. the touch 319 followed by a drag in a downward direction is released), the image may bounce up in the opposite direction (diagram 305) to be displayed with the blank area having a length 323b, as shown in diagram 307. Next, the image may bounce down in the opposite direction and pass the critical point to be displayed with the blank area having a length 323c at, as shown in diagram 309. And, the image may bounce up again to be thereby displayed to fit the size of the display unit 132 as shown in diagram 311. In some implementation's, the image may bounce up and down at least two times.

Stated succinctly, in some implementations, when the detecting that the touch 319 followed by a drag in a downward direction is released in diagram 303 of FIG. 3, the controller 140 may move the image, which has been moved down by the amount corresponding to the length 323a, in the upward (opposite) direction as if the image bounced back, and display the image that passes through the image reaches the end 313 of the display region, as shown in diagram 305 of FIG. 3, and is moved by the amount corresponding to the length 323a+the length 323b, as shown in diagram 307 of FIG. 3. At this time, a blank area having the length 323b and the image the upper portion of which is cut off by the length 323b may be displayed on the display region 315. Further, the controller 140 may move the image, which has been moved up by the amount corresponding to the length 323a+the length 323b, in the downward (opposite) direction again as if the image bounced back, and display the image that passes through the end 313 of the display region and is moved by the amount corresponding to the length 323b+the length 323c, as shown in diagram 309 of FIG. 3. At this time, a blank area having a length 323c and the image the lower portion of which is cut off by the length 323c may be displayed on the display region 315. Further, the controller 140 may move the image, which has been moved down by the amount corresponding to the length 323b+the length 323c, in the upward (opposite) direction again as if the image bounced back, and then stop the image and display the stopped image when the boundary line of the image coincides with the end 313 of the display region, as shown in diagram 311 of FIG. 3. The visual feedback by which the image is moved in the up-and-down direction as described above may be performed at least once.

At this time, the screen moves by the distance 323b at the beginning and then by the distance 323c shorter than the distance 323b, as shown in diagrams 307 and 309. The distance of screen movement may gradually decrease and the speed of screen movement may gradually increase or decrease, depending on time. Further, the distance of screen movement may be configured by the user or may be pre-set in the electronic device, but it is not limited thereto.

Stated succinctly, in some implementations, when the screen is initially dragged, as shown in diagram 301, the edge E2 of the screen may appear to move past the edge B2 of the device bezel by a distance 321a and the blank area 321 may be displayed next to the edge E1 of the screen. Next, when a bounce event is detected, the screen may bounce in the opposite direction, such that the edge E1 of the screen appears to travel past the bezel edge B1 by the distance 323b while the blank area is displayed next to the edge E2. Next, the edge E2 of the screen may again appear to move past the bezel edge B2 by the distance 323c and the blank area may be displayed next to the edge E1. Finally, the screen may be displayed in a stationary state, as shown in diagram 311.

Turning to FIG. 4, when a touching and dragging to the left 413 is detected on the screen where an image is displayed, as shown in diagram 401, the controller 140 may determine whether the boundary line of the image reaches the end 313 of the display region. Upon determining that the boundary line of the image reaches the end 313 of the display region, the controller 140 may display the image that is moved to the left by the amount corresponding to the size 417a in the direction of the dragging to the left 413, as shown in diagram 403 of FIG. 4. At this time, the dragging is still in progress. Subsequently, the image that has been moved to the left may be displayed with the blank area 415, as shown in diagram 403. The blank area is intended to visually inform that there is no more area and/or image to be displayed. At this time, a bouncing event may be detected on the screen, as shown in diagram 403. That is, the removal of the dragging may be detected on the screen, as shown in diagram 403. When the dragging is removed on the screen where the blank area is displayed, as shown in diagram 403, it is determined that the bouncing gesture is detected. Accordingly, the image may bounce in the opposite direction, i.e., to the right and pass the end 313 of the display region as shown in diagram 405 to be thereby displayed with the blank area having a length 417b at the left side of the display unit 132, as shown in diagram 407. Next, the image may bounce again in the opposite direction, i.e., to the left and pass the critical point to be thereby displayed with the blank area having a length 417c at the right side of the display unit 132, as shown in diagram 409. And, the image may bounce to the right again to thereby fit the size of the display unit 132, as shown in diagram 411.

Stated succinctly, in some implementations, when the dragging to the left 413 is released in diagram 403 of FIG. 4, the controller 140 may move the image, which has been moved to the left by the amount corresponding to the length 417a, in the rightward (opposite) direction as if the image bounced back, and display the image that passes through the end 313 of the display region, as shown in diagram 405 of FIG. 4, and is moved by the amount corresponding to the length 417a+the length 417b, as shown in diagram 407 of FIG. 4. At this time, a blank area having the length 417b and the image the right portion of which is cut off by the length 417b may be displayed on the display region 315. Further, the controller 140 may move the image, which has been moved to the right by the amount corresponding to the length 417a+the length 417b, in the leftward (opposite) direction again as if the image bounced back, and display the image that passes through the end 313 of the display region and is moved by the amount corresponding to the length 417b+the length 417c, as shown in diagram 409 of FIG. 4. At this time, a blank area having the size 417c and the image the left portion of which is cut off by the length 417c may be displayed on the display region 315. Further, the controller 140 may move the image, which has been moved to the left by the amount corresponding to the length 417b+the length 417c, in the rightward (opposite) direction again as if the image bounced back, and then stop the image and display the stopped image when the boundary line of the image coincides with the end 313 of the display region, as shown in diagram 411 of FIG. 4. The visual feedback by which the image is moved in the left-and-right direction as described above may be performed at least once.

As illustrated, the screen moves by the distance 417b at the beginning and then by the distance 417c shorter than the distance 417b, as shown in diagrams 407 and 409. Thus, the distance of screen movement may gradually decrease and the speed of screen movement may gradually increase or decrease, depending on time.

Turning to FIG. 5, when a touching 515 followed by a dragging in a diagonal direction to the upper left corner is detected on a screen, as shown in diagram 501, the controller 140 may determine whether the boundary line of the image reaches the end 313 of the display region. Upon determining that the boundary line of the image reaches the end 313 of the display region, the controller 140 may display the image that is moved diagonally to the top left corner by the amount corresponding to the size 519a in the direction of the dragging diagonally to the top left corner 515, as shown in diagram 503 of FIG. 5. At this time, the dragging is still in progress. Subsequently, the image that has been moved in the diagonal direction to the upper left corner may be displayed with the blank area 517, as shown in diagram 503. The blank area may visually inform that there is no more area and/or image to be displayed. At this time, a bouncing event may be detected. Accordingly, the image may bounce in the opposite direction, i.e., to the lower right corner and pass the critical point 313 as shown in diagram 505 to be thereby displayed with the blank area having a length 519b at the upper left corner of the display unit 132, as shown in diagram 507. Next, the image may bounce again in the opposite direction, i.e., to the upper left corner and pass the end 313 of the display region to be thereby displayed with the blank area having a length 519c at the lower right corner of the display unit 132, as shown in diagram 509. And, the image may bounce to the lower right corner again to be thereby displayed to fit the size of the display unit 132 as shown in diagram 511.

Stated succinctly, in some implementations, when that the dragging diagonally to the top left corner 515 is released in diagram 503 of FIG. 5, the controller 140 may move the image, which has been moved diagonally to the top left corner, diagonally to the bottom right corner (in the opposite direction) as if the image bounced back, and display the image that passes through the end 313 of the display region, as shown in diagram 505 of FIG. 5, and is moved by the amount corresponding to the length 519a+the length 519b, as shown in diagram 507 of FIG. 5. At this time, a blank area having the length 519b with respect to the top left corner and the image the right lower portion of which is cut off by the length 519b may be displayed on the display region 315. Further, the controller 140 may move the image, which has been moved diagonally to the bottom right corner by the amount corresponding to the length 519a+the length 519b, diagonally to the top left corner (in the opposite direction) again as if the image bounced back, and display the image that passes through the end 313 of the display region and is moved by the amount corresponding to the length 519b+the length 519c, as shown in diagram 509 of FIG. 5. At this time, a blank area having the length 519c with respect to the bottom right corner and the image the left upper portion of which is cut off by the length 519c may be displayed on the display region 315. Further, the controller 140 may move the image, which has been moved diagonally to the top left corner by the amount corresponding to the length 519b+the length 519c, diagonally to the bottom right corner (in the opposite direction) again as if the image bounced back, and then stop the image and display the stopped image when the boundary line of the image coincides with the end 313 of the display region, as shown in diagram 511 of FIG. 5. The visual feedback by which the image is moved in the left upward-and-right downward direction as described above may be performed at least once.

In this example, the screen moves by the distance 519b at the beginning and then by the distance 519c shorter than the distance 519b, as shown in diagrams 507 and 509. Thus, the distance of the screen movement may gradually decrease and the speed of the screen movement may gradually increase, depending on time. Stated succinctly, in some implementations, when initially dragged, the screen may move by a distance 517a in a first direction. The first direction may one that is defined by the movement of the user's finger over the device's touchscreen. When the screen is moved in the first direction, the edges E1 and E3 of the screen appear to move past the edges B1 and B3, respectively, of the device's bezel and the blank area is displayed next to the screen edges E2 and E4. Next, when the screen is bounced back, the screen moves by distance 519b in a second direction opposite the first direction. When the screen is bounced back, the edges E2 and E4 appear to travel past the bezel edges B2 and B4 and the blank area is displayed next to the screen edges E1 and E3. Next, the screen may bounce back and move in the first direction again by distance 519c. And finally, the screen may be displayed in a stationary state, as shown in diagram 511.

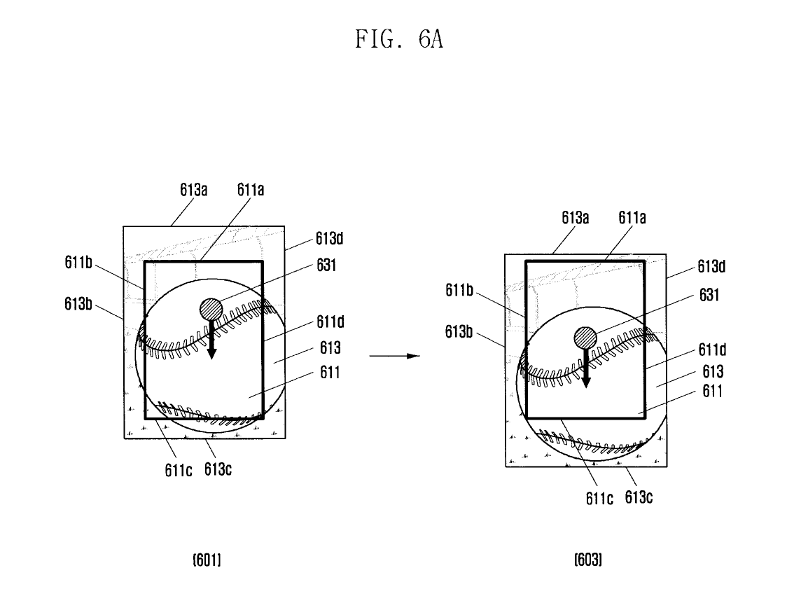

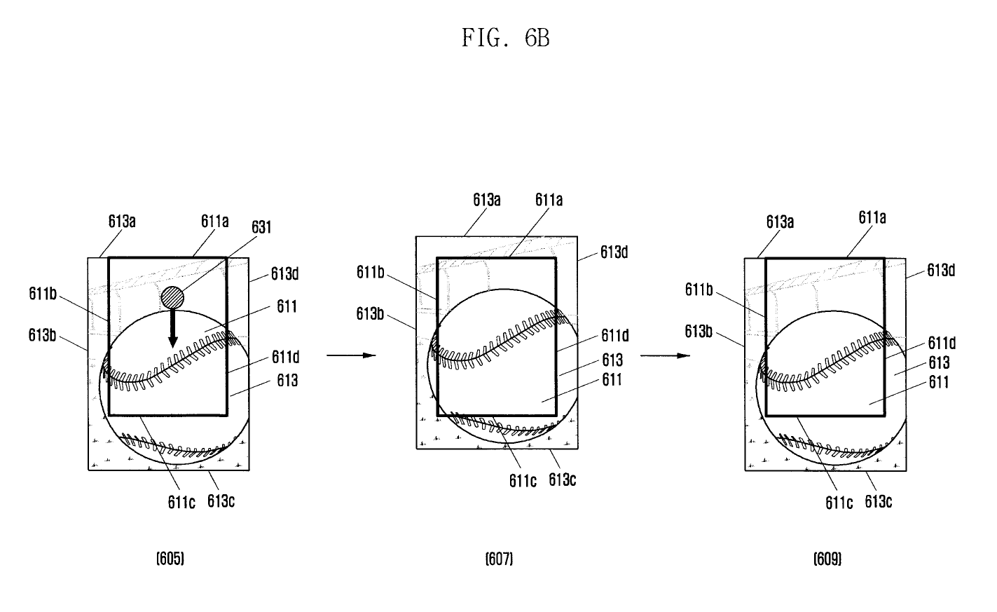

FIGS. 6A-C are diagrams illustrating an example of a process for controlling screen movement, according to aspects of the disclosure. The display region 611 may include the entire visible area of the display unit 132 or a portion thereof. For example, the display region 611 may be a window that is smaller than the entire visible area of the display unit 132. In some implementations, only portions of the image 611 that are located inside the display region 611 may visible to the user. By contrast, those portions of the image 613 that fall outside of the display region 611 may remain hidden from the user. The display region 611 may include the upper end 611a, the left end 611b, the lower end 611c, and the right end 611d. The image 613 may include the upper boundary line 613a, the left boundary line 613b, the lower boundary line 613c, and the right boundary line 613d.

After the image 611 is displayed, a drag 631 may be performed on the image, as shown in diagram 601. Next, in response to the drag, the controller 140 moves the image 613 in the downward direction along with the finger and/or stylus performing the drag, as shown in diagrams 603 and 605. Next, when it is determined that the upper boundary line 613a of the image 613 has reached the upper end 611a of the display region 611, as shown in diagram 605, the controller 140 may change the direction in which the image is moved by moving the image in the upward direction. By doing so, the controller 140 may create the visual appearance of the image being bounced back. The controller 140 may move the image 613 in the upward direction until the image 613 is centered with the display area 611, as shown in diagram 607. Afterwards, the controller 140 may bounce the image 611 back in the downward direction once more until the upper boundary line 613a of the image 613 coincides with the upper end 611a of the display region 611, as shown in diagram 609.

Although in this example, the image 613 is moved only until the boundary lines of the image reach the ends of the display region 611, in other implementations the boundary lines of the image 613 may move past the ends of the display region, as shown in FIG. 6C. More specifically, when the upper boundary line 613a of the image 613 moves past the upper end 611a of the display region 611, a blank area 661 may be displayed, as shown in diagram 651. Next, after the upper boundary line 613a has moved a predetermined distance past the upper end 611a of the display region 611, the controller 140 may move the image in the opposite direction, as shown in diagram 653.

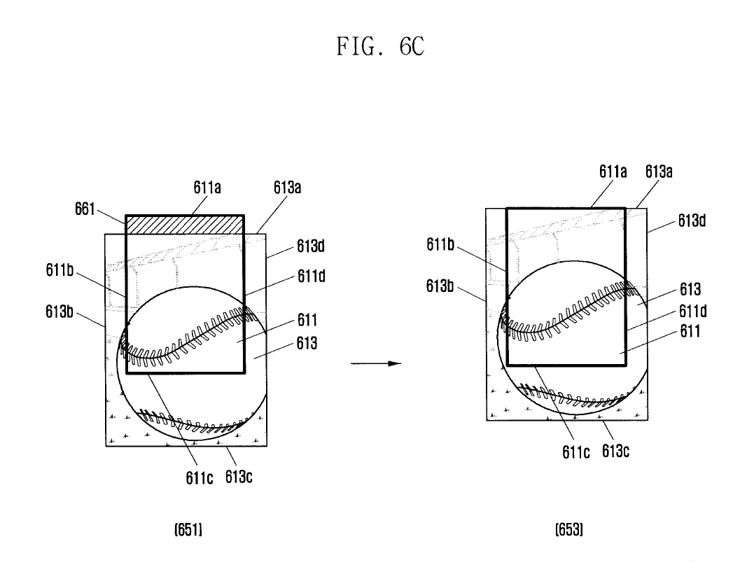

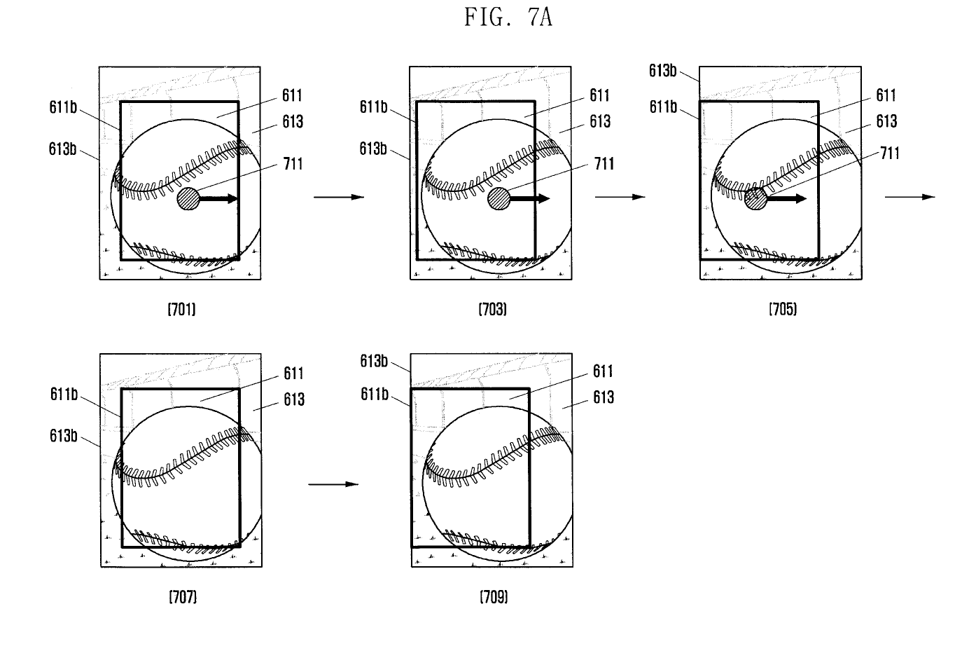

FIGS. 7A-B are diagrams illustrating an example of a process for controlling screen movement, according to aspects of the disclosure. According to the process, the image 613 is displayed in the display region 611, and a drag 711 is detected, as shown in diagram 701. Next, in response to the drag, the controller 140 controller moves the image in the rightward direction, along with the finger and/or stylus that performs the drag 711, until the left boundary line 613b of the image reaches the left end 611b of the display region, as shown in diagram 703. Next, in response to determining the boundary line 613b has reached the left end 611b of the image, while the stylus and/or finger performing the drag 711 is still touching the display unit 132, the controller moves the image 613 back in the leftward direction, thereby giving the impression that the image 613 is being bounced off the edge of the display area 611, as shown in diagram 705. In some implementations, the controller 140 moves the image 613 in the leftward direction until the image 613 is centered with the display area 611, as shown in diagram 707. Next, in response to determining that the image 613 is centered with the display area 611, the controller 140 moves the image back in the rightward direction, as shown in diagram 709.

Although in this example, the image 613 is moved only until the boundary lines of the image reach the ends of the display region 611, in other implementations the boundary lines of the image 613 may move past the ends of the display region, as shown in FIG. 7B. More specifically, when the left boundary line 613b of the image 613 moves past the left end 61ba of the display region 611, a blank area 731 may be displayed, as shown in diagram 721. Next, after the left boundary line 613b has moved a predetermined distance past the left end 611b of the display region 611, the controller 140 may move the image in the opposite direction <723>.

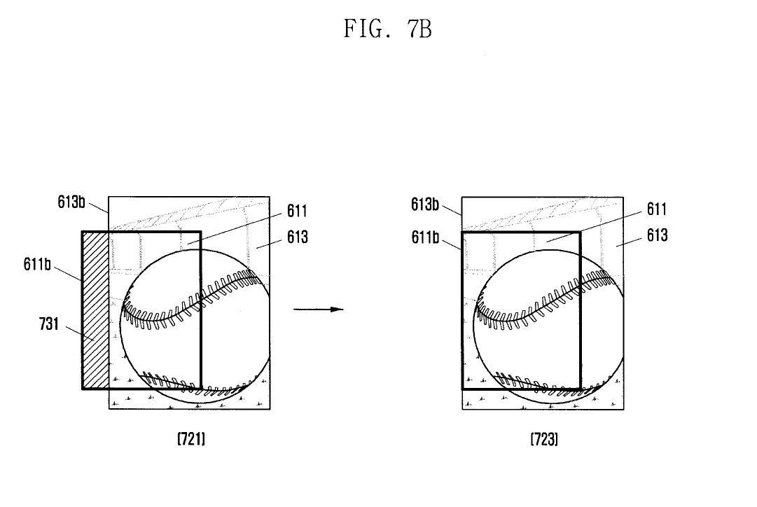

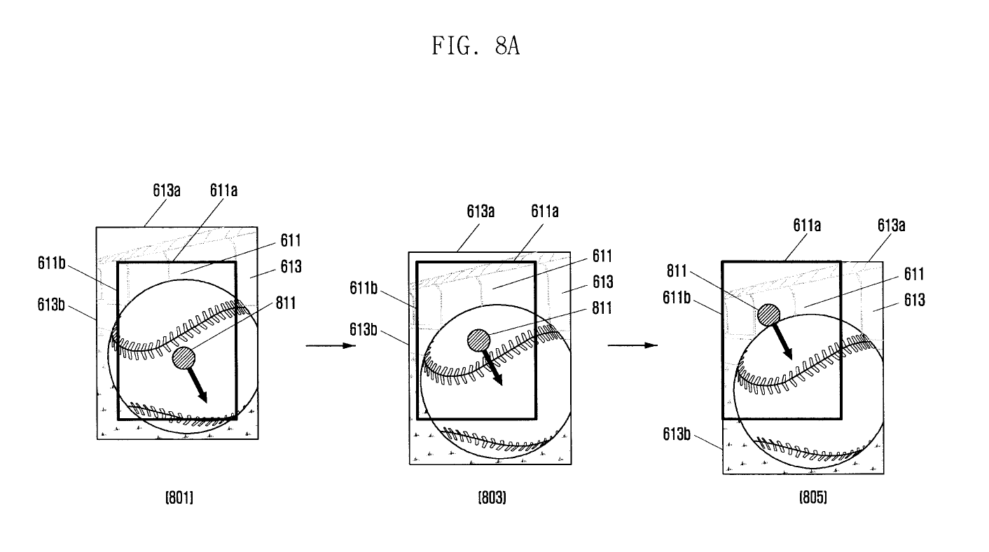

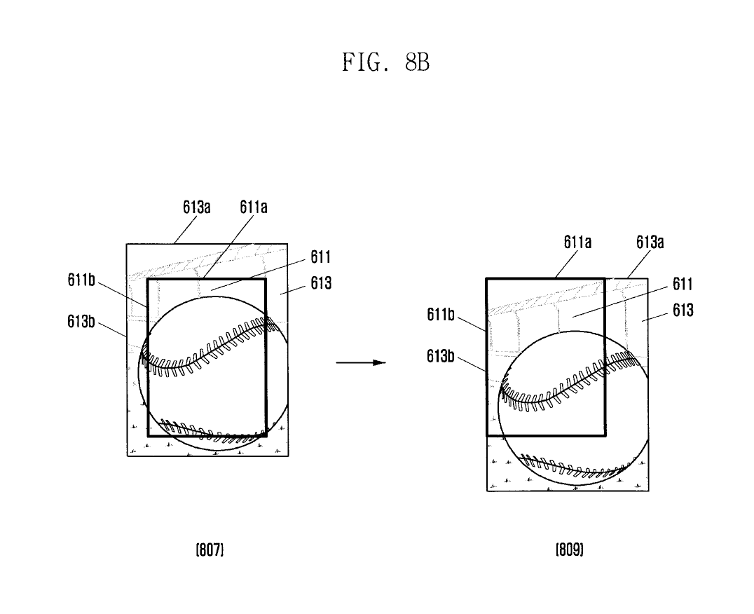

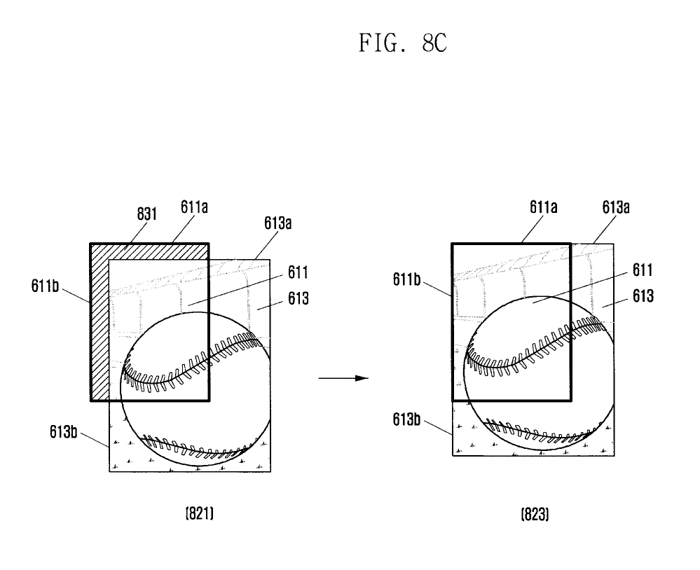

FIGS. 8A-C are diagrams illustrating an example of a process for controlling screen movement, according to aspects of the disclosure. According to the process, the controller 140 may detect a diagonal dragging gesture 811 while the image 613 is displayed, as shown in diagram 801. Next, in response to the dragging gesture 811, the controller 140 may move the image diagonally, along with the finger or stylus performing the dragging gesture 811, until the top boundary line 613a and the left boundary line 613b of the image 613 have reached the left end 611a and top end 611b of the display region 611, as shown in diagram 803. Next, in response to determining that the top and left boundary lines 613a-b have reached the top and left ends 611a-b, while the finger and/or stylus performing the dragging gesture 811 is still making contact with the touchscreen 130, the controller 114 moves the image 613 back in the opposite direction, thereby creating the impression that the image 613 is being bounced off the ends of the display region 611, as shown in diagram 805. Next, when the image 613 becomes again centered with the display region 611, the controller 140 may again move the image 613 in the first direction, as illustrated in diagram 807. As illustrated, the controller 140 may move the image 613 in the first direction until the top and left boundary lines 613a-b again reach the top and left ends 611a-b of the display region 611, as shown in diagram 809.

Although in this example, the image 613 is moved only until the boundary lines of the image reach the ends of the display region 611, in other implementations the boundary lines of the image 613 may move past the ends of the display region, as shown in FIG. 8C. As illustrated, in these implementations a blank area 831 may be displayed after the boundary lines of the image have moved past the ends of the display region.

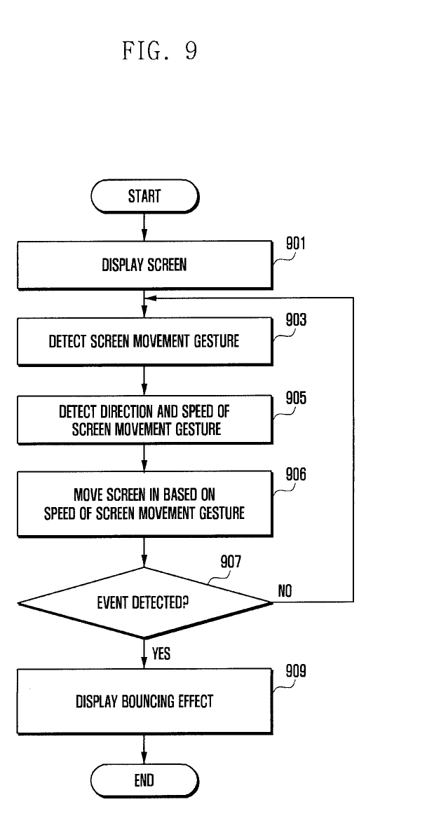

FIG. 9 is a flowchart of an example of a process, according to aspects of the disclosure. Referring to FIG. 9, the controller 140 may display a screen in operation 901. For example, the screen may be an application screen (e.g., a media player screen, an e-book screen, an Internet browser screen, etc.) a map, a menu comprising a plurality of icons, a menu comprising a plurality of thumbnails, a list of items (e.g., menu items, text items, link items), etc. In some implementations, the screen may be a scrollable screen.

In operation 903, the controller 140 may detect a screen movement gesture while the screen is displayed. In operation 905, the controller 140 detects the direction and speed of the screen movement gesture. In operation 906, the controller 140 moves the screen in the direction of the screen movement gesture on the basis of the gesture's speed. For example, when the result of analyzing the direction and speed of the screen movement gesture shows that the speed of the gesture is fast, the controller 140 may set the screen movement distance to a large value in proportion to the fast speed and move the screen fast in the direction of the screen movement gesture. Alternatively, when the result of analyzing the direction and speed of the screen movement gesture shows that the speed of the gesture is slow, the controller 140 may set the screen movement distance to a small value in proportion to the slow speed and move the screen slowly in the direction of the screen movement gesture.

In operation 907, the controller 140 may determine whether a predetermined event is detected. For example, the controller may determine whether the boundary line of the screen has reached the end of the display region. As another example, the controller may determine whether the screen has traveled by a predetermined distance. As yet another example, the controller may determine whether the touch movement gesture is released. When the boundary line of the screen reaches the end of the display region, the controller 140 may return to operation 903 and detect the screen movement gesture.

In operation 909, in response to the predetermined event being detected, the controller 140 may display a bouncing effect. According to aspects of the disclosure, displaying the bouncing effect may include moving the screen in one direction and then moving the screen again in the opposite direction, thereby giving the impression that the screen is bouncing. In some implementations, the speed at which the screen moves during each bounce may depend on at least one of the speed and direction of the screen movement gesture. Additionally or alternatively, the distance which the screen travels past the bezel of the device, if at all, may be based on at least one of the speed and direction of the screen movement gesture. Additionally or alternatively, the direction in which the screen bounces may be based on at least one of the speed and direction of the screen movement gesture.

In an embodiment of the present disclosure, upon detecting the screen movement gesture, the controller 140 may move the screen in the direction of the screen movement gesture and determine whether the boundary line of the screen moved in the direction of the screen movement gesture reaches the end of the display region. Upon determining that the boundary line of the screen reaches the end of the display region, the controller 140 may continuously move the screen in the direction of the screen movement gesture and display a blank area on the display region. Further, when the screen movement gesture is released, the controller 140 may display the bouncing effect.

More specially, upon determining that the boundary line of the screen reaches the end of the display region, the controller 140 may display the screen the boundary line of which is moved by a first amount, determined on the basis of the direction and speed of the screen movement gesture, from the end of the display region in the first direction. Upon detecting that the screen movement gesture is released, the controller 140 may move the screen, which has been moved in the first direction, by a second amount, determined on the basis of the direction and speed of the screen movement gesture, in the second direction. The second amount may be larger than the first amount. The controller 140 may move the screen, which has been moved in the second direction, in the first direction again, and then stop the screen and display the stopped screen when the boundary line of the screen coincides with the end of the display region.

Further, in an embodiment of the present disclosure, upon detecting the screen movement gesture for moving the screen in the first direction, the controller 140 may display the screen that is moved in the first direction. When the boundary line of the screen moved in the first direction reaches the end of the display region, the controller 140 may move the screen, which has been moved in the first direction, by the distance, determined on the basis of the direction and speed of the screen movement gesture, in the second direction opposite to the first direction. The controller 140 may move the screen, which has been moved in the second direction, in the first direction again, and then stop the screen and display the stopped screen when the boundary line of the screen coincides with the end of the display region.

In an embodiment of the present disclosure, the bouncing effect may be displayed at the same time as when it is determined that the boundary line of the screen reaches the end of the display region while the screen movement gesture is continuously detected or may occur a predetermined period of time (e.g., 3 seconds) after it is determined that the boundary line of the screen reaches the end of the display region. Alternatively, the bouncing effect may occur at the same time as when it is determined that the boundary line of the screen reaches the end of the display region and the screen movement gesture is released.

In an embodiment of the present disclosure, the speed of the bouncing effect may be set such that it gets faster or slower as time goes by. For example, when the speed of the screen movement gesture is determined to be fast, the controller 140 may display a bouncing effect having a first range of screen movement distance and a first speed. Alternatively, when the speed of the screen movement gesture is determined to be slow, the controller 140 may display a bouncing effect having a second range of screen movement distance and a second speed. In some implementations, the second range may be smaller than the first range and/or the second speed may be lower than the first speed.

In an embodiment of the present disclosure, when the bouncing effect is displayed, the controller 140 may reset the screen movement distance.

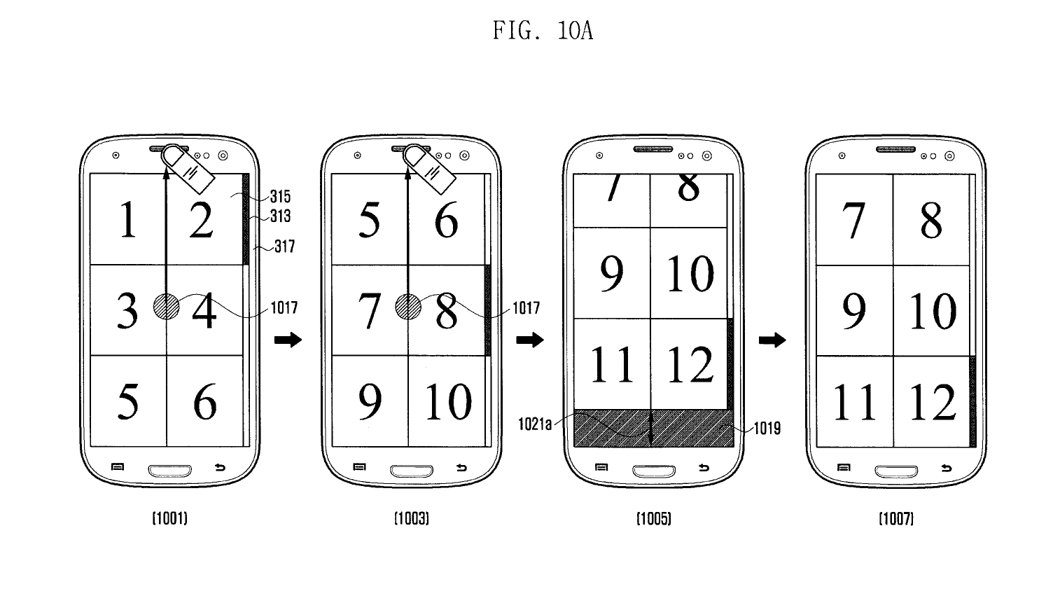

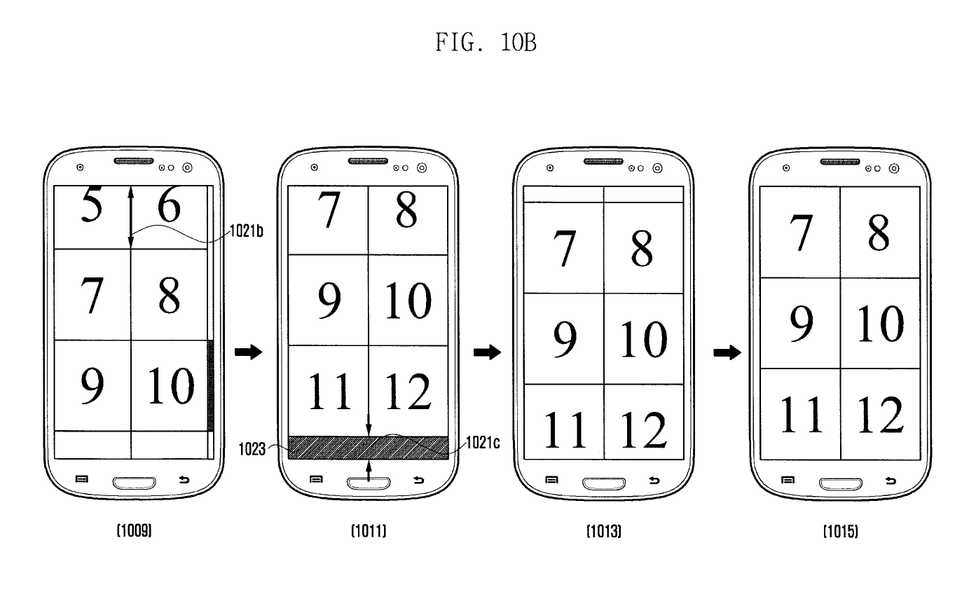

FIGS. 10A-B are diagrams illustrating an example of a process for controlling screen movement, according to aspects of the disclosure. According to the process, when a touch 1017 followed by a dragging in an upward direction is detected on the screen (the screen consisting of images of “1, 2, 3, 4, 5 and 6”), as shown in diagram 1001, the controller 140 may analyze the speed of the dragging up 1017. The controller 140 may display the screen (including images 5, 6, 7, 8, 9, and 10) in diagram 1003 of FIG. 10A, which succeeds to the screen in diagram 1001 of FIG. 10A, while moving the screen up in proportion to the analyzed speed. The controller 140 may determine whether the boundary line of the screen reaches the end of the display region in diagram 1003 of FIG. 10A.

The controller 140 may determine that the boundary line of the screen in diagram 1003 of FIG. 10A, which has been moved in the upward direction, does not reach the end of the display region. The controller 140 may detect the dragging up 1017 on the screen (including images 5, 6, 7, 8, 9, and 10) in diagram 1003 of FIG. 10A. The controller 140 may analyze the speed of the dragging up 1017. The controller 140 may move the screen up in proportion to the analyzed speed in response to the dragging up 1017, as shown in diagram 1005 of FIG. 10A, and determine whether the boundary line of the screen reaches the end of the display region. When the boundary line of the screen in diagram 1003 of FIG. 10A reaches the end of the display region, the controller 140 may move the screen up in proportion to the analyzed speed and display the screen (including a part of image 7, a part of image 8, images 9, 10, 11, and 12, and a blank area 1019) in diagram 1005 of FIG. 10A, which succeeds to the screen in diagram 1003 of FIG. 10A. At this time, the boundary line of the displayed screen is moved by the amount corresponding to the size 1021a from the end of the display region. Further, when it is determined that the boundary line of the screen reaches the end of the display region and the screen movement gesture is released in diagram 1005 of FIG. 10A, and therefore, when the screen travels past the edge of the top bezel of the electronic device, the blank area 1019 is displayed. The blank area may visually inform that there are no images in the screen to be displayed. At this time, a bouncing event may be detected. Accordingly, the screen may bounce down, i.e., in move the opposite direction, so that the screen shown in diagram 1009 (the screen consisting of images of “5, 6, 7, 8, 9 and 10”) is displayed. For example, the screen may move down by a distance 1021b. Next, the screen shown diagram 1009 may bounce up again to thereby display the screen shown in diagram 1011. At this time, the blank area corresponding to the moving distance 1021b may be displayed. And then, the screen shown in diagram 1011 may bounce down to thereby display the screen shown in diagram 1013 that has been moved by a distance 1021c. Next, the screen shown in diagram 1013 may move up again to thereby display the screen shown in diagram 1015 that fits the size of the display unit 132 and remains static afterwards. As described above, the screen may bounce up and down at least two times.

In some aspects, When it is determined that the boundary line of the screen reaches the end of the display region and the screen movement gesture is released in diagram 1005 of FIG. 10A, the controller 140 may move the screen in the downward (opposite) direction in proportion to the analyzed speed of the dragging 1017 as if the screen bounced back. For example, the controller 140 may display the screen that passes through the end 313 of the display region, as shown by the screen (including images 7, 8, 9, 10, 11, and 12) in diagram 1007 of FIG. 10A, and then is moved to the screen (including 5, 6, 7, 8, 9, and 10) as shown in diagram 1009 of FIG. B. Further, the controller 140 may move the screen, which has been moved down as shown in diagram 1009 of FIG. 10B, beyond the end 313 of the display region in the upward direction as if the screen bounced back, and display the screen that includes a blank area 1023 having the size indicated by “1021c” with respect to the end 313 of display region, as shown in diagram 1011 of FIG. 10B. Further, the controller 140 may move the screen, which has been moved up as shown in diagram 1011 of FIG. 10B, in the downward direction again as if the screen bounced back, and display the screen that has passed through the end 313 of the display region, as shown in diagram 1013 of FIG. 10B. Subsequently, the controller 140 may move the screen, which has been moved down as shown in diagram 1013 of FIG. 10B, in the upward direction again, and then stop the screen and display the stopped screen when the lower boundary line of the screen coincides with the lower end of the display region, as shown in diagram 1015 of FIG. 10B.

In some aspects, the movement distance of the screen may vary while the bouncing effect is displayed. As illustrated, the screen moves by the distance 1021a at the beginning, then by the distance 1021b shorter than the distance 1021a, and then by the distance 1021c shorter than the distance 1021b, as shown in diagrams 1009 and 1013 of FIG. 10B. The distance of screen movement may gradually decrease and the speed of screen movement may gradually increase, over the course of the bouncing effect's display. Further, the distance of screen movement and the number of bounces may be preset by the user or in the electronic device or may be configured to be proportional to the gesture speed, but it is not limited thereto.

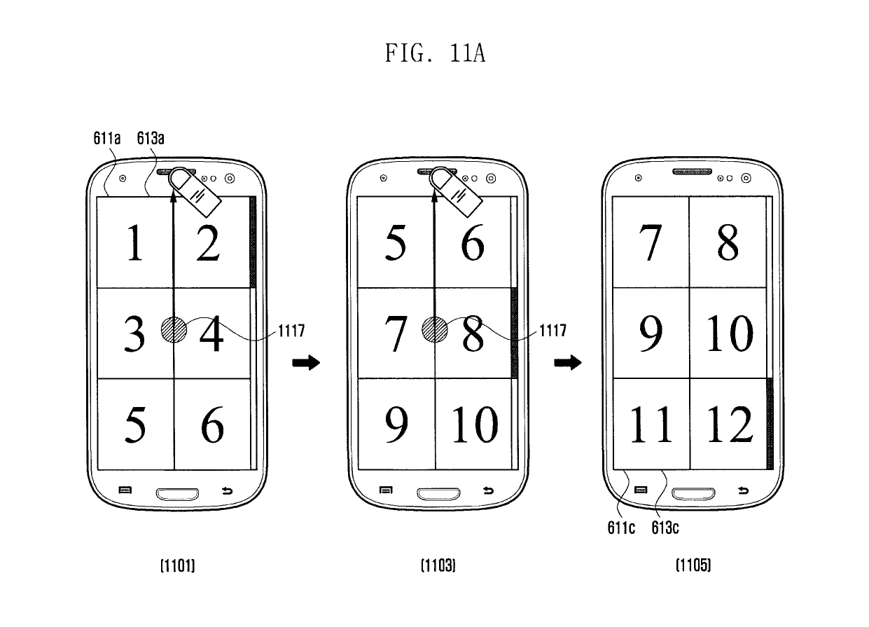

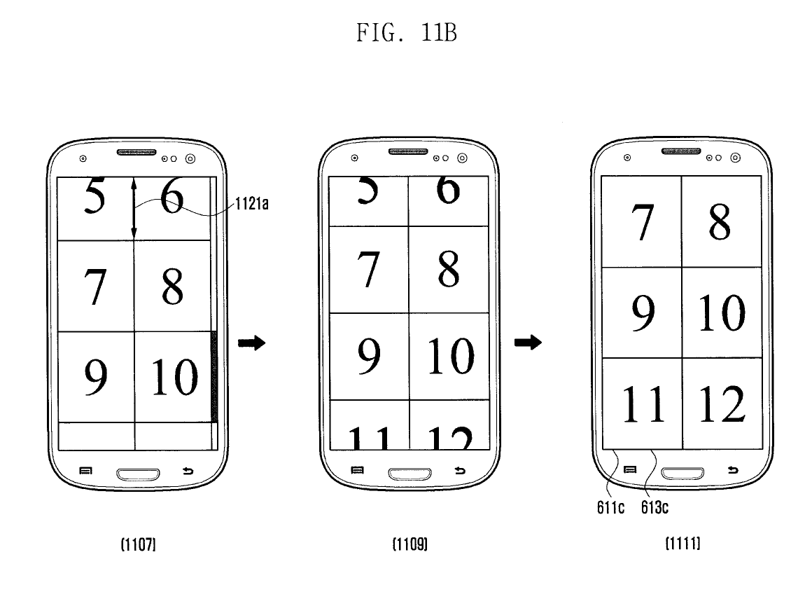

FIGS. 11A-B are diagrams illustrating an example of a process for controlling screen movement, according to aspects of the disclosure. More specially, the screen (including images 1, 2, 3, 4, 5, and 6) in diagram 1101 of FIG. 11A may be a screen that is displayed such that the upper boundary line 613a of the screen coincides with the upper end 611a of the display region. Upon detecting a dragging gesture 1117, the controller 140 may display the screen (including images 5, 6, 7, 8, 9, and 10) in diagram 1103 of FIG. 11A, which succeeds to the screen in diagram 1101 of FIG. 11A, while moving the screen up in proportion to the speed of the gesture. Since the screen in diagram 1103 of FIG. 11A does not correspond to the end of the screen (e.g., the first or last page), the controller may determine that the boundary line of the screen does not reach the end of the display region.

Upon continuously detecting the dragging up 1117 on the screen (including images 5, 6, 7, 8, 9, and 10) in diagram 1103 of FIG. 11A, the controller 140 may analyze the speed of the dragging up 1117 and determine whether the screen in diagram 1003 of FIG. 10A corresponds to the end of the screen. The controller 140 may display the screen (including images 7, 8, 9, 10, 11, and 12) in diagram 1105 of FIG. 11A, which succeeds to the screen in diagram 1103 of FIG. 11A, while moving the screen up in proportion to the analyzed speed. The controller may determine the boundary line of the screen reaches the end of the display region in diagram 1105 of FIG. 11A, moves the screen down in the opposite direction by a distance 1121a as if the screen bounced back, as shown in diagram 1107 of FIG. 11B. Further, the controller 140 may move the screen, which has been moved down by the distance 1121a, in the upward direction as if the screen bounced back, as shown in diagram 1109 of FIG. 11B, and then stop the screen and display the stopped screen when the lower boundary line of the screen coincides with the lower end of the display region, as shown in diagram 1111 of FIG. 11B.

In some implementations, when the bouncing effect is displayed, the movement distance of the screen may decrease with each successive bounce. For example, the distance by which the screen appears to travel past the bezel of the electronic device (and/or end of display region) may be greater the first time the screen bounces, than it is when the screen bounces for a second time.

FIGS. 1-11B are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. An electronic device comprising a display unit and a controller configured to:
display a screen on the display unit;
in response to a first input, move the screen in a first direction by a first distance and hiding a first portion of the screen; and
in response to an event generated while the screen is moving in the first direction, display a visual effect, the visual effect including bouncing the screen for a first time by moving the screen in a second direction by a second distance and hiding a second portion of the screen,
wherein the second direction is opposite the first direction and the second distance is greater than the first distance.

2. The electronic device of claim 1, wherein
the controller is further configured to detecting at least one of a direction and speed of the first input; and
the second distance is determined based on at least one of the direction of the first input and speed of the first input.

3. The electronic device of claim 1, wherein the controller is further configured to move the screen in the first direction by a third distance, the third distance being different from the first distance and the second distance.

4. The electronic device of claim 1, wherein the controller is further configured to, while the portion of the screen is hidden, display, a blank area for visually indicating that there is no further screen to be displayed.

5. The electronic device of claim 4, wherein a size of the blank area is changed as the screen is moved in the first direction.

6. An electronic device comprising a display unit and a controller configured to:
display a screen on the display unit;
in response to a first input, move the screen in a first direction by a first distance until a boundary line of the screen reaches an end of the display unit; and
bounce the screen for a first time by moving the screen in a second direction by a second distance and hide a second portion of the screen,
wherein the second direction is opposite the first direction.

7. The electronic device of claim 6, wherein, the screen is bounced in response to the boundary line reaching the end of the display unit.

8. The electronic device of claim 6, wherein the screen is bounced in response to the first input being released.

9. A method comprising:
displaying a screen on a display unit of an electronic device;
in response to a first input, moving the screen in a first direction by a first distance and hiding a first portion of the screen; and
in response to an event generated while the screen is moving in the first direction, displaying a visual effect, the visual effect including bouncing the screen for a first time by moving the screen in a second direction by a second distance and hiding a second portion of the screen,
wherein the second direction is opposite the first direction and the second distance is greater than the first distance.

10. The method of claim 9, further comprising:
detecting at least one of a direction and speed of the first input; and
wherein the second distance is determined based on at least one of the direction of the first input and speed of the first input.

11. The method of claim 9, further comprising moving the screen in the first direction by a third distance, the third distance being different from the first distance and the second distance.

12. The method of claim 9, further comprising, while the portion of the screen is hidden, displaying, a blank area for visually indicating that there is no further screen to be displayed.

13. The method of claim 12, wherein a size of the blank area is changed as the screen is moved in the first direction.

14. A method comprising:
displaying a screen on a display unit of an electronic device;
in response to a first input, moving the screen in a first direction by a first distance until a boundary line of the screen reaches an end of the display unit; and
bouncing the screen for a first time by moving the screen in a second direction by a second distance and hiding a second portion of the screen,
wherein the second direction is opposite the first direction.

15. The method of claim 14, wherein, the screen is bounced in response to the boundary line reaching the end of the display unit.

16. The method of claim 14, wherein the screen is bounced in response to the first input being released.
